(19) United States
(12) Patent Application Publication
(10) Pub. No.: US 2017/0354992 A1
(43) Pub. Date: Dec. 14, 2017

(54) LINEAR VIBRATION MOTOR

(71) Applicant: Nidec Copal Corporation, Tokyo (JP)

(72) Inventor: Yoshinori KATADA, Tokyo (JP)

(73) Assignee: Nidec Copal Corporation, Tokyo (JP)

(21) Appl. No.: 15/543,863

(22) PCT Filed: Jan. 15, 2016
(86) PCT No.: PCT/JP2016/051096

§ 371 Date: Jul. 14, 2017

(30) Foreign Application Priority Data
Jan. 16, 2015 (JP) 2015-007251

(51) Int. Cl. B06B 1/04; H02K 33/00

(52) U.S. Cl. CPC B06B 1/045; H02K 33/00

(57) ABSTRACT

A linear vibration motor has a cover body made from a magnetic material having a planar inner surface (supporting face); a movable element that comprises a magnet and a weight, and that vibrates in the axial direction along the inner surface; an elastic member elastically repelling the vibration of the movable element; and a coil, secured in relation to the cover body, and wherein a winding part that is perpendicular, in respect to the axial direction, to a gap between the movable element and the cover body, where supporting portions for supporting the movable element through the elastic member are provided on both axial-direction end portions on the cover body.

### CROSS-REFERENCE TO RELATED APPLICATIONS

This is a U.S. national phase application under 35 U.S.C. §371 of International Patent Application No. PCT/JP2016/051096, filed Jan. 15, 2016, and claims benefit of priority to Japanese Patent Application No. 2015-007251, filed Jan. 16, 2015. The entire contents of these applications are hereby incorporated by reference.

### FIELD OF TECHNOLOGY

The present invention relates to a linear vibration motor that causes a movable element to undergo linearly reciprocating vibration through a signal input.

### BACKGROUND

A vibration motor (or a vibration actuator) is that which communicates, to a user of a communication device or to an operator who is holding any of a variety of electronic devices, the state of an input signal through a vibration, through generating a vibration through an incoming call on a communication device or through the transmission of an alarm on any of a variety of electronic devices, and is built into any of a variety of electronic devices, such as mobile information terminals, including mobile telephones.

Among the various forms of vibration motors that are under development, there are known linear vibration motors that are able to generate relatively large vibrations through linear reciprocating vibrations of a movable element. A conventional linear motor is provided with a weight and a magnet on a movable element side, where an electric current is applied to a coil that is provided on the stator side to cause the Lorentz forces that act on the magnet to form a driving force, to cause the movable element, which is elastically supported along the direction of vibration, to undergo reciprocating vibrations (referencing Japanese Unexamined Patent Application Publication 2011-97747).

### SUMMARY

With smaller and thinner mobile electronic devices there is the need for smaller and thinner vibration motors to be equipped therein. In particular, in electronic devices that are provided with flat-panel display portions, such as smartphones, the space within the device in the direction of thickness, which is perpendicular to the display panel, is limited, and thus there is a strong need for the vibration motor, which is equipped therein, to be thinner.

Moreover, the conventional linear vibration motor is provided with a case, where this case supports a guide shaft, a coil, and the like. In this type of conventional technology, when installed in a mobile electronic device, the case of the linear vibration motor will be present on the inside of the case of the mobile electronic device, and thus there is a problem in that the space within the mobile electronic device, wherein there are strong needs for miniaturization, is not used effectively, due to the existence of this redundant case. While, in this regard, one may consider avoiding the redundant case through assembling the components of the linear vibration motor within the case of the mobile electronic device, doing this would make it impossible to confirm the initial characteristics of the linear vibration motor prior to the completion of the assembly of the electronic device, and thus there is a problem in that this limits the issues that can be checked, and prevents a confirmation that the device will operate properly.

In the present invention, the handling of such problems is an example of the problem to be solved. That is, the objects of the present invention are to achieve a reduction in the thickness of the linear vibration motor through forming the movable element in a flat shape, the effective utilization of space within the about electronic device, the ability to check properly the initial operation of the linear vibration motor, and the like.

In order to achieve such an object, the present invention is provided with the following structures:

A linear vibration motor having a cover unit that has a flat inner surface; a movable element comprising a magnet and a weight, for vibrating in the axial direction along the inner surface; an elastic member for elastically repelling the vibration of the movable element; and a coil that is secured to the cover unit, and wherein a coil part that is perpendicular to the axial direction is disposed in a space between the movable element and the cover unit, wherein: a supporting portion for supporting the movable element is provided in the cover unit, at both end portions in the axial direction, with elastic members therebetween.

The present invention, having distinctive features such as set forth above, enables a movable element with a flat shape to be vibrated stably with a structure that achieves a reduction in thickness of the linear vibration motor and that avoids complex assembly through having the movable element be of a flat shape.

Moreover, because all of the components for which the initial operations can be checked are assembled onto the cover unit, and the cover unit can be assembled onto the machine body frame of the mobile electronic device after the operating checks have been completed, the space within the mobile electronic device can be used effectively, and the initial operation of the linear vibration motor can be checked properly.

### BRIEF DESCRIPTIONS OF THE DRAWINGS

FIG. 1 is an explanatory diagram (an assembly perspective diagram) illustrating the overall structure of a linear vibration motor according to an embodiment according to the present invention.

FIG. 2 is a plan view of a linear vibration motor according to an embodiment according to the present invention is viewed from the top face.

FIG. 3 is a cross-sectional diagram (a cross-sectional diagram along section A-A in FIG. 2) of a linear vibration motor according to an embodiment according to the present invention.

FIG. 4 is a perspective diagram illustrating the assembled state of a linear vibration motor according to an embodiment according to the present invention.

FIG. 5 is an explanatory diagram (an assembly perspective diagram) illustrating the overall structure of a linear vibration motor according to another embodiment according to the present invention.

FIG. 6 is an explanatory diagram illustrating a mobile electronic device (a mobile information terminal) in which is provided a linear vibration motor according to an embodiment according to the present invention.

### DETAILED DESCRIPTION

Examples according to the present invention will be explained below in reference to the drawings. In the drawings below, locations that are depicted identically in the various drawings are assigned identical reference symbols, and redundant explanations are omitted. In the drawings, the direction of vibration (the axial direction) is defined as the X axial direction, and the directions perpendicular thereto are defined as the Y axial direction (the width direction) and the Z axial direction (the height direction).

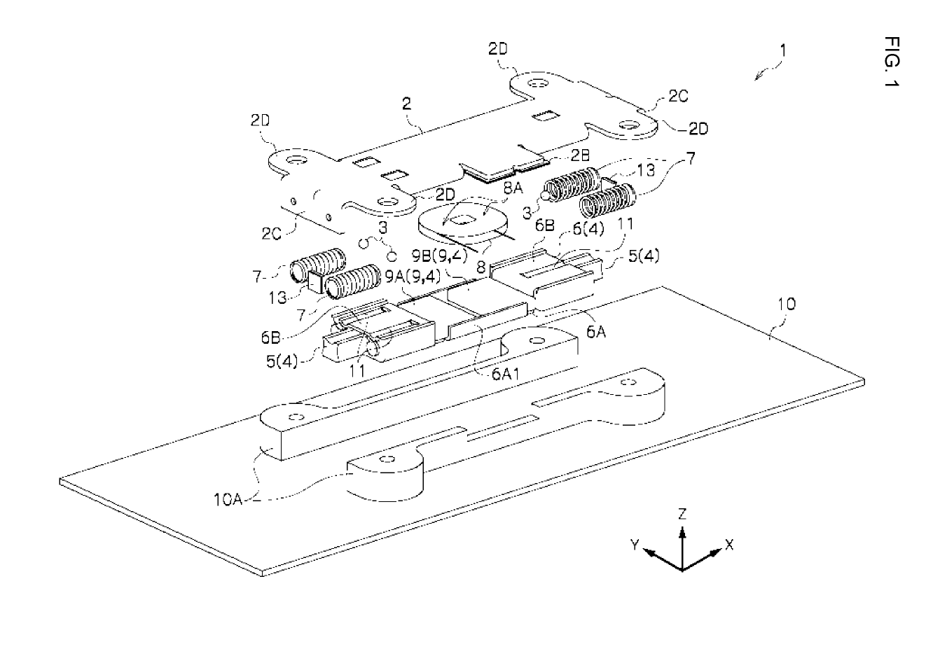

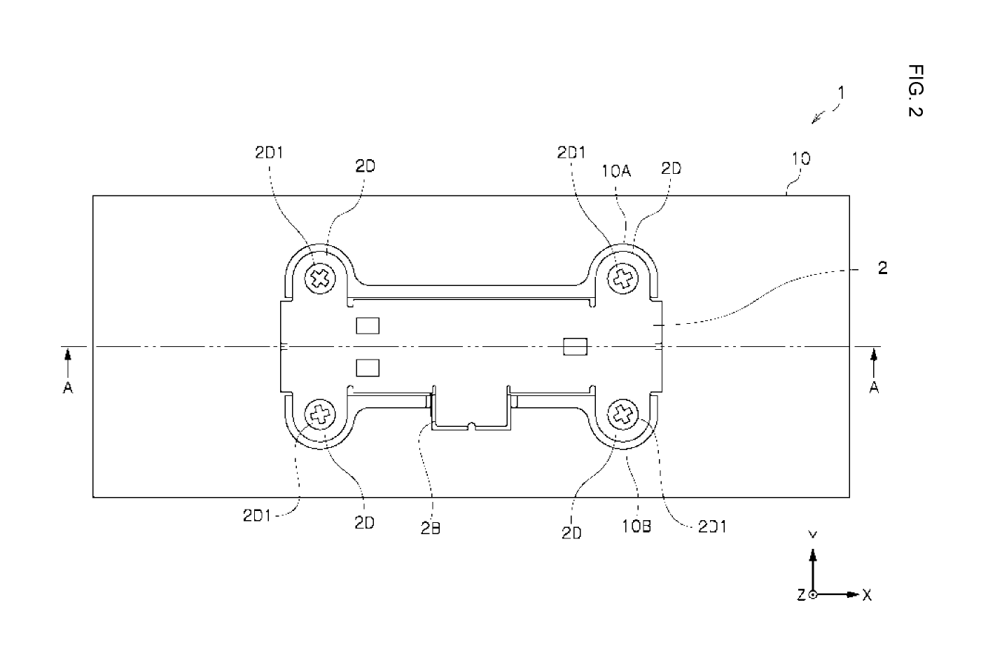

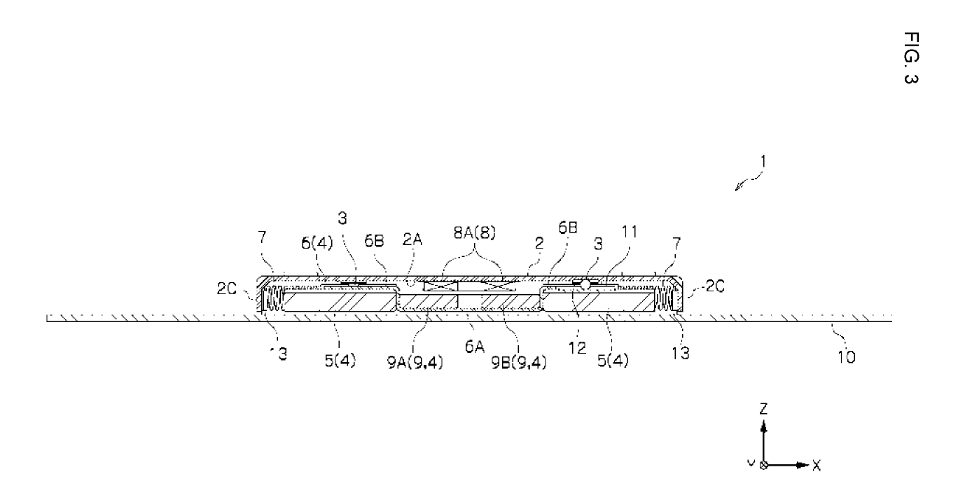

As illustrated in FIG. 1 (an exploded perspective diagram), FIG. 2 (a plan view), and FIG. 3 (a cross-sectional view along the section A-A in FIG. 2), the linear vibration motor 1 according to the example according to the present invention comprises a cover unit 2, a movable element 4, elastic members 7, and a coil 8, and is attached to a machine body frame 10 of a mobile electronic device.

The cover unit 2 is a top cover that is installed on the machine body frame 10 of the mobile electronic device, and is made from a magnetic material that has a flat inner surface (supporting surface) 2A, where a signal inputting terminal portion 2B to which a terminal of the coil 8 is connected, and an attaching portion 2D for attaching to the machine body frame 10, are formed extending on the side portion.

The movable element 4 is provided with a weight 5, a magnet 9, and a connecting body 6 for connecting therebetween, and is in partial contact, through contact pieces 3 at a plurality of locations (preferably three locations) of the supporting surface 2A in the cover unit 2. While in the example in the figure an example is depicted wherein the cover unit 2 and the movable element 4 are in partial contact through the contact pieces 3, instead protruding portions that protrude in the Z axial direction may be provided on the cover unit 2 side or the movable element 4 side, and these may be brought into partial contact directly.

Preferably the contact pieces 3 are rolling elements that make rolling contact with the cover unit 2 side and the movable element 4 side. As illustrated, the rolling elements may be spherical bodies that make point contacts with the cover unit 2 side and the movable element 4 side, or may be cylindrical bodies (rollers) that make linear contact with the cover unit 2 side and the movable element 4 side.

The movable element 4 vibrates in the axial direction (the X axial direction in the figure) along the supporting surface 2A, while maintaining partial contact with the cover unit 2. Guiding grooves 11 that hold the contact pieces 3 are provided on the movable element 4 side, where these guiding groove 11 extend along the direction of vibration (the X axial direction in the figure) of the movable element 4. In the example in the figures, an example is depicted wherein the guiding grooves 11 are provided on the movable element 4 side, and holding grooves 12 for holding the contact pieces 3 are provided on the cover unit 2 side; however, the guiding grooves 11 may instead be provided on the cover unit 2 side with the holding grooves 12 on the movable element 4 side, or guiding grooves 11 may be provided on both the cover unit 2 side and the movable element 4 side.

In the coil 8 for driving the movable element 4, a coil part 8A is disposed perpendicular in respect to the axial direction (the X axial direction in the figure) in a space between the movable element 4 and the cover unit 2, and is secured in relation to the cover unit 2. In the example in the figure, the coil 8 is wound in a flat shape in a gap between the magnet 9 and the cover unit 2. The aforementioned coil part 8A regulates the direction of the current that produces the Lorentz forces for causing the movable element 4 to vibrate in the X axial direction, and insofar as such a coil part 8A is formed, how the coil 8 itself is wound is not limited to the example in the figures.

The magnet 9 that is equipped in the movable element 4 produces the magnetic flux that passes through the coil part 8A of the coil 8, described above, between the cover unit 2 that is of a magnetic material (a yoke), and has a function for producing magnetic attraction of the movable element 4 toward the supporting surface 2A side of the cover unit 2. In the example in the figures, the magnet 9 comprises a pair of magnet pieces 9A and 9B that have mutually opposing directions of magnetization in the direction that is perpendicular to the supporting surface 2A (the Z axial direction in the figure), where these magnet pieces 9A and 9B are disposed facing the coil part 8A of the coil 8, so as to form magnetic flux that passes through the coil part 8A in the Z axial direction.

The weights 5 that are provided in the movable element 4 are disposed in a pair along the axial direction (the X axial direction in the figure), with the magnet 9 held therebetween. Through this, in the movable element 4, the pair of weights 5 and the magnet 9 that is disposed therebetween, are laid out in a row along the axial direction (the X axial direction in the figure). The connecting body 6 that connects these weights 5 and the magnet 9 into a single unit is a bent plate-shaped member comprising a magnetic supporting portion 6A for supporting the bottom face side (the side that is opposite from the side that faces the cover unit 2) of the magnet 9, and weight supporting portions 6B for supporting the top face sides (the sides that face the cover unit 2) of the weights 5. The magnet 9, the weights 5, and the connecting body 6 are joined together through adhesive bonding, welding, or the like. Note that, if necessary, the magnetic supporting portion 6A is provided with a reinforcing portion 6A1 that is bent in the Z axial direction.

Guiding grooves 11 for holding the contact pieces 3 on the connecting body 6 may be provided in the weight supporting portion 6B of the connecting body 6. The provision of the guiding grooves 11 in the connecting body 6 in this way makes it possible to select the material for the connecting body 6 to reduce the contact resistance with the contact pieces 3 within the guiding groove 11.

Moreover, with the connecting body 6 being a magnetic member, a magnetic circuit is structured from the magnet 9 and the cover unit 2. At this time, the weight supporting portions 6B, wherein are formed the guiding grooves 11 for holding the contact pieces 3, will be in a state that is adjacent to the cover unit 2 with a contact piece 3 therebetween, and thus the magnetic attraction between the weight supporting portion 6B and the cover unit 2 is increased, enabling an increase in magnetic attraction on the movable element 4 toward the cover unit 2 side in a state wherein the contact pieces 3 are held reliably between the guiding grooves 11 and the holding grooves 12.

The elastic members 7 are springs (for example, coil springs) for elastically repelling the vibration along the axial direction of the movable element 4, and have one end side of each supported on supporting portion 2C that are provided at both axial direction end portions (in the X axial direction in the figure) in the cover unit 2. The other end side of each elastic member 7 is supported on an end face of the weight 5. Moreover, a shock absorbing material 13 is attached so as to prevent a sound from being produced when an end portion of the weight 5 strikes the inner surface side of the supporting portion 2C.

Such a linear vibration motor 1 is driven by Lorentz forces that act on the magnet 9 through application of an electric current to the coil 8, to undergo linear reciprocating vibration along the axial direction (the X axial direction in the figure). At this time, the flat movable element 4 will vibrate along the supporting surface 2A while maintaining a state of partial contact at a plurality of locations (preferably, three locations) with the flat supporting surface 2A in the cover unit 2, due to the magnetic attraction between the cover unit 2 and the magnet 9. This suppresses rolling of the flat movable element 4 around the axes of vibration, enabling a stable linear vibration.

In the linear vibration motor 1, the coil 8 is secured to the cover unit 2 side, and in a state wherein the movable element 4 makes partial contact through the contact pieces 3, the elastic members 7 are installed between the end portions of the movable element 4 (the end portions of the weights 5) and the supporting portion 2C of the cover unit 2, to complete the assembly operation on the cover unit 2 side. At this time, forming the plane of the supporting surface 2A of the cover unit 2 accurately eliminates the need for high-accuracy assembly operations during assembly. Moreover, the guide shafts are eliminated, which can also reduce the number of components.

Given this, when the assembly of components onto the cover unit 2 side has been completed, the linear vibration motor 1 can be driven in this state, making it possible to check the initial operation of the linear vibration motor 1 prior to installation into the machine body frame 10. At this time, the movable element 4 and the elastic members 7 are exposed to the outside of the linear vibration motor 1. After the checks on the initial operation have been completed, then with the components equipped on the cover unit 2 side, attachment to the attaching portion 10A of the machine body frame 10 is possible in this state. An attaching portion 2D is provided on the cover unit 2, and the operation for assembling into the mobile electronic device can be completed easily through merely placing this onto the attaching portion 10A of the frame 10 and installing the attaching hardware (screws) 2D1.

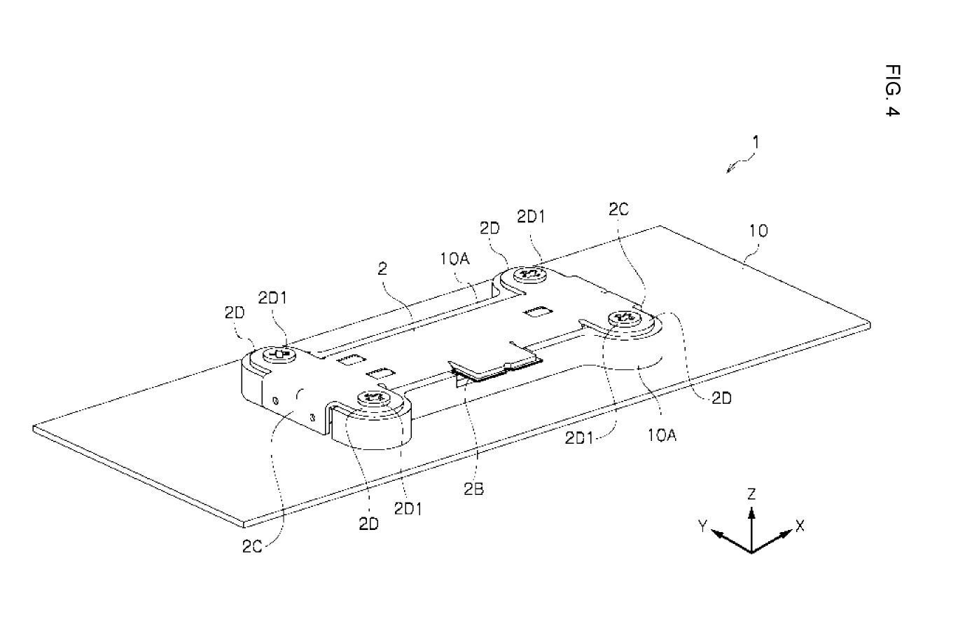

FIG. 4 depicts a state wherein the linear vibration motor 1 is assembled onto the machine body frame 10 of the mobile electronic device. In this linear vibration motor 1, the cover unit 2 serves as a top cover for covering one surface of the movable element 4, where the attaching portion 10A, which is provided on the machine body frame 10 side of the mobile electronic device, serves as a side frame for cover at the side of the movable element 4. In this way, the space within the mobile electronic device can be used effectively through forming the frame for the linear vibration motor 1 on the machine body frame 10 side of the mobile electronic device, without having to provide a frame on the linear vibration motor 1.

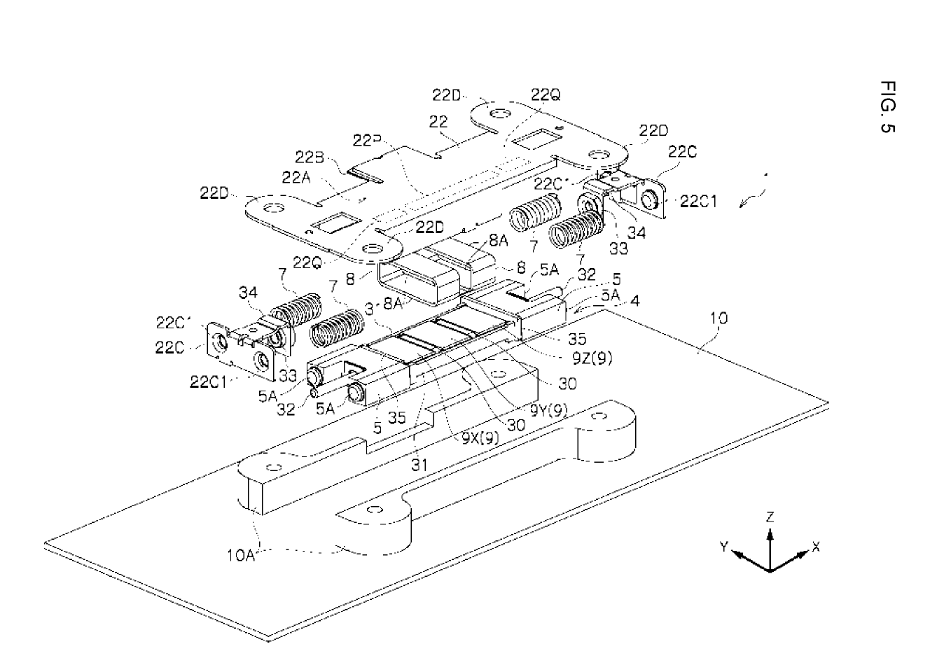

FIG. 5 illustrates another example of a linear vibration motor 1. The parts that are the same as that which has been explained above are assigned identical reference symbols, and redundant explanations are partially omitted. The linear vibration motor 1 in this example, as with the previous example, comprises a cover unit 22, a movable element 4, elastic members 7, and coils 8.

The cover unit 22 is a top cover that is installed on the machine body frame 10 of the mobile electronic device, and has a flat inner surface 22A, where a signal inputting terminal portion 22B to which a terminal of the coils 8 is connected, and an attaching portion 22D for attaching to the machine body frame 10, are formed extending on the side portion. The cover unit 22 is attached to the attaching portion 10A of the machine body frame 10 by passing the attaching hardware 2D1, described above, through the holes in the attaching portion 22D.

The movable element 4 comprises a pair of weights 5 that are disposed separated from each other in the direction of vibration (the X axial direction in the figure), and a magnet 9 that is disposed held between the pair of weights 5. The magnet 9 comprises a plurality (which, in the figure, is 3) of magnet pieces 9X, 9Y, and 9Z, along the direction of vibration. The magnet pieces 9X, 9Y, and 9Z are magnetized along the direction of vibration, with identical poles in mutually facing high [sic—probably at a typographical error for “each other”], with spacers 30 interposed therebetween. The weights 5 and the magnet 9 are connected together, through the connecting member 35, and reinforced integrally through a strengthening member 31 that is provided extending along the direction of vibration.

In such a movable element 4, the elastic members 7 are supported, so as to enable vibration, on supporting portions 22C that are provided at both end portions in the direction of vibration (the axial direction) of the cover unit 22. Protruding portions 5A, for holding the elastic members 7, are provided on the axial-direction end portions of the movable elements 4 at the weights 5, and protruding portions 22C1, for holding elastic members 7, are provided at positions facing the protruding portions 5A on the supporting portion 22C side as well.

Moreover, a bearing supporting portion 34, for supporting a bearing 33, is provided on the supporting portion 22C, where a guide shaft 32 that is provided in the movable element 4 so as to protrude from both axial direction ends of the weights 5 is supported on the bearing 33. In the example in the figure, an example is depicted wherein the guide shaft 32 is secured on the movable element 4 side, and a bearing 33 is secured on the supporting portion 22C side; however the structure may be the opposite instead, wherein the guide shaft 32 is secured to the supporting portion 22C side and the bearing 33 is secured to the movable element 4 (weight 5) side.

The coil 8 that is secured to the cover unit 22 (which, in the example in the figure, is two coils 8) is wound on the peripheries of the spacers 30 that are disposed between the magnet pieces 9X, 9Y, and 9Z, so that a coil part 8A that is perpendicular to the axial direction (the X axial direction in the figure) is disposed in the gaps between the movable element 4 and the cover unit 22.

The linear vibration motor 1 in the example illustrated in FIG. 5 as well, as with the example illustrated in FIG. 4, is assembled onto the machine body frame 10 of the mobile electronic device. In the linear vibration motor 1 illustrated in FIG. 5 as well the cover unit 22 serves as the top cover for one surface side of the movable element 4, and the attaching portion 10A that is provided on the machine body frame 10 side of the mobile electronic device serves as the side frame that covers the sides of the movable element 4.

In this example, the guide shaft 32 is supported in the movable element 4 through the bearing 33 of the supporting portion 22C, and the movable element 4 is supported on the cover unit 22, so that the cover unit 22 need not necessarily be a magnetic member. However, a supporting face that is of a magnetic material is provided on a portion of the inner surface of the cover unit 22, to support a portion of the movable element 4 in a state wherein the movable element 4 rotates around the guide shaft 32, in partial contact with the magnetic materials supporting face.

Moreover, as illustrated in FIG. 5, a partial magnetic material portion 22P and a supporting face 22Q are provided on the inner surface of the cover unit 22, and the magnetic material portion 22P corresponds to the position of the magnet 9, and thus a portion of the magnet 9 is magnetically attracted to the supporting face 22Q side wherein the cover unit 22 is provided, to allow the movable element 4 to rotate around the guide shaft 32, and to allow a portion of the movable element 4 (for example, the corner portion of the connecting member 35) to slide, supported on the supporting face 22Q.

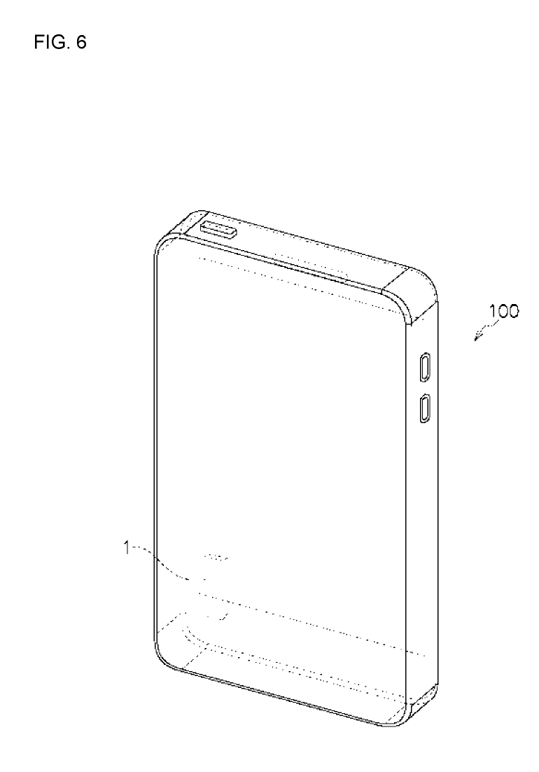

FIG. 6 illustrates a mobile information terminal 100 as one example of a mobile electronic device equipped with a linear vibration motor 1 according to an example according to the present invention. The mobile information terminal 100 that is equipped with the linear vibration motor 1 that can produce a stabilized vibration and for which the thickness can be reduced and which can be made more compact in the width direction enables the user to be notified through a stabilized vibration that does not tend to produce noise, when there is an incoming call in a communication function or at the beginning or end of an operation such as an alarm function. Moreover, this makes it possible to produce a mobile information terminal 100 with high mobility and which facilitates design performance, through the linear vibration motor 1 having reduced thickness and being more compact in the width direction. Moreover, because the linear vibration motor 1 uses the machine body frame of the mobile information terminal 100 as the frame, the linear vibration motor 1 can be installed in a thinner mobile information terminal 100, with good spatial efficiency.

While examples according to the present invention were described in detail above, referencing the drawings, the specific structures thereof are not limited to these examples, but rather design variations within a range that does not deviate from the spirit and intent of the present invention are also included in the present invention.

1. A linear vibration motor comprising:
a cover unit that has a flat inner surface;
a movable element comprising a magnet and a weight, for vibrating in the axial direction along the inner surface;
an elastic member elastically repelling the vibration of the movable element; and
a coil secured to the cover unit, and wherein a coil part that is perpendicular to the axial direction is disposed in a space between the movable element and the cover unit, wherein:
a supporting portion for supporting the movable element is provided in the cover unit, at both end portions in the axial direction, with elastic members there between.

2. The linear vibration motor as set forth in claim 1, wherein:
an inner surface of the cover unit is a supporting face of a magnetic material wherein the movable element is supported at a plurality of locations, either directly or through contact pieces

3. The linear vibration motor as set forth in claim 2, wherein:
the magnet forms a magnetic flux that passes through the coil part of the coil in the space between itself and the cover unit, and magnetically attracts the movable element toward the supporting surface side.

4. The linear vibration motor as set forth in claim 2, wherein:
the contact is a rolling element, and makes either point contact or line contact on the cover unit side and the movable element side.

5. The linear vibration motor as set forth in any one of claim 2, wherein:
the magnet is a pair of magnet pieces having directions of magnetization that are mutually opposing, in a direction that is perpendicular to the supporting surface; and
the coil is wound in a flat shape in a gap between the magnet and the cover unit.

6. The linear vibration motor as set forth in claim 1, wherein:
the cover unit comprises an attaching portion for attaching to a machine body frame of the mobile electronic device in which it is installed.

7. A mobile electronic device comprising a linear vibration motor as set forth in claim 1, comprising a machine body frame that has an attaching portion to which the cover unit attaches.

8. The mobile electronic device as set forth in claim 7, wherein:
the attaching portion serves as a side frame for the linear vibration motor.
